(19) United States
(12) Patent Application Publication
(10) Pub. No.: US 2026/0021008 A1
(43) Pub. Date: Jan. 22, 2026

(54) METHOD FOR TRAINING THE EYES OF AN OCCUPANT IN A VEHICLE

(71) Applicant: MERCEDES-BENZ GROUP AG, Stuttgart (DE)

(72) Inventor: Gudrun SCHÖNHERR, Holzgerlingen (DE)

(21) Appl. No.: 18/993,065

(22) PCT Filed: Dec. 8, 2023
(86) PCT No.: PCT/EP2023/084822

§ 371 Date: Jan. 10, 2025

(30) Foreign Application Priority Data
Jan. 12, 2023 (DE) 10 2023 000 055.8

(51) Int. Cl. A61H 5/00; G06F 3/01

(52) U.S. Cl. CPC A61H 5/00; G06F 3/012; G06F 3/013; G06F 3/016; A61H 2230/42; A61H 2230/62

(57) ABSTRACT

Eyes of an occupant in a vehicle are trained by recording a head position and/or an eye movement of the occupant, displaying lines and/or dots are displayed on a display unit, asking the occupant to track a course of the lines by head movement or by eye movement, and outputting feedback on a respectively recorded head position and/or eye movement of the occupant.

### BACKGROUND AND SUMMARY OF THE INVENTION

Exemplary embodiments of the invention relate to a method for training the eyes of an occupant in a vehicle.

WO 2013/111003 A1 discloses a system for training the eyes of a person, in which the person is repeatedly presented with luminous shapes. The luminous shapes each have at least one sharp contrast line delimiting a first region of the respective luminous shape from a second region of the respective luminous shape or constituting an outer boundary of the luminous shape. The repeatedly presented luminous shapes differ at least in terms of their distance from the person. The system contains a luminous shape presentation means, which can be actuated in order to change at least the distance of the repeatedly presentable luminous shapes from the head position of the person. In addition, WO 2013/111003 A1 discloses a method for training the eyes of a person, with the method providing that the person is repeatedly presented with luminous shapes.

Exemplary embodiments of the invention are directed to a novel method for training the eyes of a vehicle occupant.

According to the invention, a method for training the eyes of an occupant in a vehicle provides that a head position and/or an eye movement of the occupant are or is recorded. Lines and/or dots are displayed on a display unit, whereby the occupant is asked to track a course of the lines by means of head movement or by means of eye movement and feedback on a respectively recorded head position and/or eye movement of the occupant is output.

By applying the method, the eyes of the occupant, for example a driver of the vehicle, can be trained while charging an electric energy store of the vehicle at a charging station. In this case, the eye muscles are relaxed, for example. When applying the method during such a break, the eyes can relax, while at the same time metabolic stimulation in the neck and shoulder region of the occupant can take place.

During a break in driving the vehicle, the occupant, in particular the driver of the vehicle, or another occupant when the vehicle is being driven, is offered eye relaxation and metabolic stimulation in the neck and shoulder region.

In one embodiment of the method, a recorded occupant movement is displayed mirrored on the display unit. The occupant therefore sees themselves on the display unit in front of them and can observe and track their head and/or eye movements.

Another embodiment of the method provides that a nose tip on a face of the occupant is displayed as a dot on the display unit. In this case, the nose tip represents a drawing tool, whereby movements of the nose tip caused by head movements of the occupant are correspondingly depicted as lines and/or other shapes on the display unit. The movements of the nose lead to micro-movements in the occupant's neck, causing the neck muscles to relax.

By moving the head, in one development of the method, a two-dimensional shape is drawn by means of the nose tip, which shape is displayed on the display unit. Using the nose tip, the occupant can fulfil certain tasks by painting the predefined two-dimensional shape, in particular using the nose tip, with the painting being displayed on the display unit. The occupant thus sees the results of their nose movements on the display unit.

In one development of the method, the breathing of the occupant is monitored during the training. In particular, breathing is monitored because the person often stops breathing during such exercises, for example to increase concentration and/or to avoid wobbling.

If it is determined that the occupant stops breathing when carrying out training or that their breathing falters, one embodiment of the method provides that the occupant is visually, acoustically, and/or haptically reminded to breathe, i.e., to breathe in and out. By way of example, the occupant is supported with their breathing, whereby the occupant is visually, acoustically, and/or haptically advised to breathe in and out. By way of example, a visual and/or acoustic indication is given that the occupant should now breathe in and then breathe out. For example, a time period can be specified between the indicated breathing in and breathing out.

In another possible embodiment of the method, the occupant is haptically reminded to breathe by activation of a seat massage and guided into a next breathing movement. Thus, despite concentrating and being distracted, the occupant is reminded to breathe and supported in their breathing. For example, when the occupant breathes in, an increase in the volume of the occupant's ribcage increases the degree of inflation of inflatable seat bladders inside the vehicle seat in order to perform the seat massage, which can, for example, cause the thoracic spine to move into a more upright position, giving the lungs more room for inhalation and thereby making it easier to breathe in, whereas the degree of inflation of the inflatable seat bladders decreases at the end of inhalation as the start of exhalation, causing the thoracic spine to be less upright and the ribcage to offer less volume, thus supporting exhalation more, so that a respective breathing movement of the occupant is supported by means of the inflatable seat bladders in a vehicle seat of the occupant.

In one embodiment, the occupant is reminded to breathe by means of a vibration pattern of an activated vibration function. By way of example, a vibration element in the occupant's vehicle seat vibrates at a certain frequency when the occupant is supposed to inhale, and a different frequency of the vibration prompts the occupant to exhale.

In another embodiment, the occupant is reminded of their correct posture by means of a further vibration pattern of the activated vibration function. By way of example, the further vibration pattern is used to alert the occupant to adopt an upright sitting posture and head posture on the vehicle seat in order to start the training.

### BRIEF DESCRIPTION OF THE DRAWING FIGURES

Exemplary embodiments of the invention are explained in more detail hereinbelow with reference to drawings, in which:

FIG. 1 schematically shows a perspective cut-away view of a vehicle with an occupant on a vehicle seat and

FIG. 2 schematically shows a device for carrying out a method for training the eyes of a vehicle occupant.

Mutually corresponding parts are given the same reference signs in all the figures.

### DETAILED DESCRIPTION

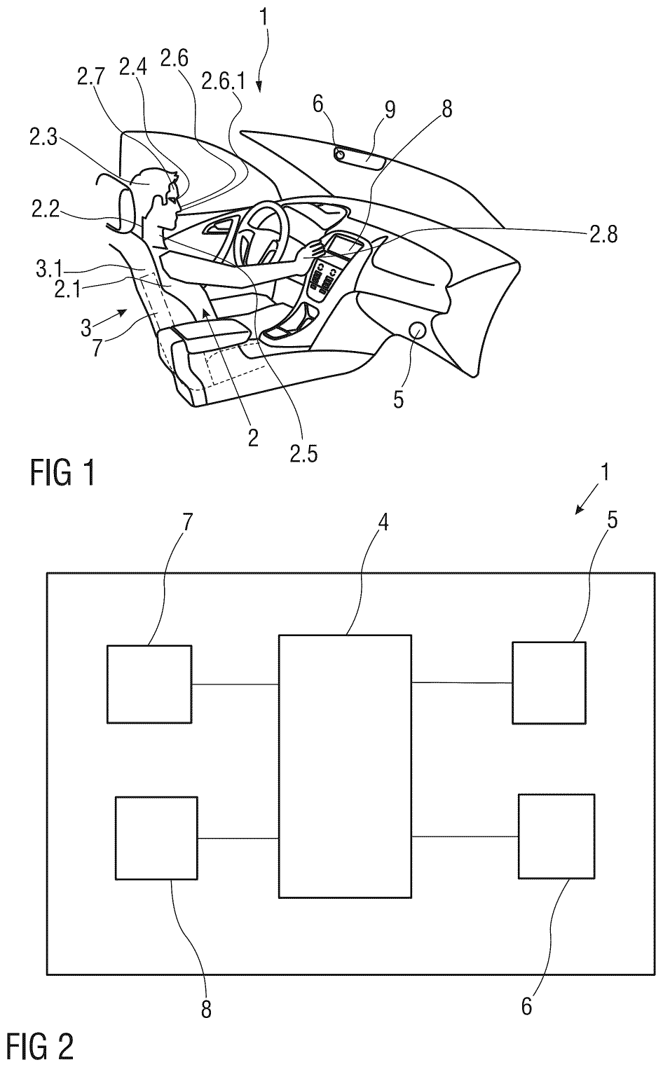

FIG. 1 shows a perspective cut-away view of a vehicle 1 with an occupant 2, in particular a driver, on a vehicle seat 3.

FIG. 2 shows a device for carrying out a method for training the eyes 2.4 of the occupant 2 in the vehicle 1.

In particular, sitting for long periods and constantly working on a mobile device, for example a smartphone, can lead to muscular tension in the back 2.1, neck 2.2, and head 2.3, and strain in the eyes 2.4.

It is generally known that ocular health, in particular in humans, is comparatively strongly linked to tension in the throat, neck and shoulder muscles and to posture and breathing behavior. The more tense a body is, the lower the blood flow and oxygen availability in cells, tissue, the brain, eye muscles, and other body structures. Tension and strain is also linked to the body and head posture of a person, in particular the occupant 2 in the vehicle 1.

Breathing comparatively slowly increases oxygen availability to ensure that the oxygen is given relatively sufficient time to reach the lungs and then enter the bloodstream.

Rules for ocular health can be derived therefrom. By way of example, a first rule states that muscles around the eyes 2.4 and muscles in a throat 2.5 and/or neck 2.2 should be relaxed and that breathing in should be comparatively slow with great expansion of the ribcage.

A second rule states that an eye movement is effected by means of muscle contractions, whereby optimized microcirculation, in particular in terms of the occupant's 2 metabolism, is possible by means of micro-movements.

A third rule states that a few minutes in a relaxed and, optionally, reclined position with closed eyes 2.4 should be used to relax the eyes 2.4.

According to the exemplary embodiment in FIG. 1, the occupant 2 sits on the vehicle seat 3, for example while an electric energy store (not shown in detail) of the vehicle 1 is being charged at a charging station, for example at a petrol station.

The occupant 2 thus has some time, whereupon they are offered eye training during the waiting time, i.e., during the charging.

The device shown in FIG. 2 for performing the eye training has a control unit 4 that is connected to a loudspeaker 5, a camera 6, a massage unit 7 integrated into the vehicle seat 3, and a user interface in the form of a display unit 8.

An exemplary embodiment of the eye training is explained in more detail hereinbelow.

By way of example, firstly, a signal is output acoustically by means of the loudspeaker 5 and/or a visually by means of the display unit 8 to begin the eye training in a non-driving situation, to follow the instructions on the display unit 8 and to sit upright on the vehicle seat 3, relax and breathe.

In a first method step of the eye training, the display unit 8 indicates that the occupant 2 should begin by taking a few slow breaths, whereby the occupant 2 should follow a breathing rhythm displayed on the display unit 8 if it supports the occupant 2.

In a second method step, the occupant 2 is invited to continue making relaxing neck movements, with lines being displayed on the display unit 8 for this purpose. The occupant 2 is asked to turn their head 2.3 to look at the left end of the line. The occupant 2 is then asked to slowly turn their head 2.3 to the right to look at the right end of the line. The occupant 2 is also asked to repeat this process a few times comparatively slowly.

In a subsequent, third method step, the occupant 2 is invited to keep their head 2.3 steady while directing their eyes 2.4 towards the far left end of the line. The eyes 2.4 should then perform a slow movement to look at the far right end of the line. This process is repeated a few times, whereby a head position of the occupant 2 is depicted mirrored on the display unit 8 in order to give the occupant 2 feedback in terms of the head and/or eye movements they have carried out.

In a fourth method step, the occupant 2 is once again asked to keep their head 2.3 steady while tracking the line with their nose 2.6 and forehead 2.7. In the process, the head 2.3 is initially turned fully to the left and then fully to the right.

A fifth method step provides that a nose tip 2.6.1 is used to paint, whereby the nose tip 2.6.1 is shown highlighted in color as a dot on the display unit 8. It is explained to the occupant 2, in particular in writing, that if the occupant 2 moves their nose tip 2.6.1, i.e. their head 2.3, the dot also moves.

The occupant 2 is, for example, asked to paint over the line from the far left to the far right several times with the nose tip 2.6.1 and to then view their result on the display unit 8.

In a sixth method step, i.e., in a next task, the occupant 2 is asked to track a line of signs displayed on the display unit 8, with each sign being shown for 10 seconds. The occupant 2 has the option to change a color, in particular of the shown signs, according to preference.

In a subsequent, seventh method step, the occupant 2 is asked to spend at least 5 minutes relaxing the eyes 2.4 and body. The occupant 2 is prompted to position a backrest 3.1 of the vehicle seat 3 in a reclined position or to start assuming a relaxed position, whereby the backrest 3.1 is tilted backwards in the relaxed position, preferably to a maximum of 45°, and/or a seat cushion (not shown) of the vehicle seat 3 is raised at the front and/or lowered at the rear. The occupant 2 should then place their hands 2.8 or an eye mask on their eyes 2.4, close their eyes 2.4 and breathe comparatively slowly.

The individual method steps to be carried out are specified by means of the control unit 4 and shown on the display unit 8.

Performing eye training in the form of so-called eye yoga, active eye relaxation and a micromobilization for the head 2.3, neck 2.2, and back 2.1 of the occupant 2 is described hereinbelow.

The occupant 2 is instructed to begin the eye training with a few calm breaths that are to become increasingly slower, and to sit upright. A body posture of the occupant 2 is displayed mirrored on the display unit 8 and the breathing is visualized. If breathing becomes slower, the head movements of the occupant 2 are displayed mirrored on the display unit 8 and a pulse of the occupant 2 should slow down.

The occupant 2 should then blink their eyes 2.4, for example 10 times. This is followed by a 30-second pause. People typically blink 30 times per minute, but much less when working on a computer.

A next task in the eye training involves looking up and down. To this end, a clock face is superimposed on the display unit 8. The occupant 2 is then instructed to direct their gaze to the 12, and from the latter slowly to the 6. In the process, the neck 2.5 should stay still and only the eyes 2.4 should move. Such an eye movement should be carried out 10 times, for example. This is followed by moving the eyes from the 3 to the 9 on the clock face.

In a subsequent task, the eyes 2.4 are circled for their mobility. In this case, the eyes 2.4 should make large circular movements. Firstly, turning to the right, while keeping neck 2.2 and throat 2.5 still. Next, the gaze should be directed upwards towards the vehicle roof and a slow clockwise circular movement with the eyes 2.4 should be carried out. This task should be carried out comparatively slowly. After three breaths have been taken, there is at least one repetition and then a change of direction, with at least one repetition being carried out in this case too.

A further task provides that the occupant 2 moves their head 2.3 from left to right and back as if on rails, while keeping their eyes 2.4 still and directing their gaze straight ahead. The further the head 2.3 is moved to the side, the more the body of the occupant 2 follows, in particular until the weight of the body comes to rest on one side of the pelvis. This sequence of movements is then performed towards the other side.

In a subsequent task, a red dot appears on the display unit 8, which is moved by the occupant 2 moving their nose tip 2.6.1. It is provided in particular for the nose tip 2.6.1 to track a line and to paint over characters. For example, the painted line or the painted characters are shown for 10 seconds and then fade out.

In this case too, it is then provided for the backrest 3.1 of the vehicle seat 3 to be positioned in the reclined position or to assume the relaxed position, whereby the occupant should keep their eyes 2.4 closed, breathe calmly, and relax.

The occupant 2—according to the exemplary embodiment shown in FIG. 1 the driver of the vehicle 1—is recorded by means of a camera 6 integrated into a rear-view mirror 9. Using image data recorded by the camera 6, coordinates are determined that relate to a head position of the occupant 2, in particular to the head 2.3 and the nose 2.6, in particular the nose tip 2.6.1.

Furthermore, the recorded image data are used to determine an eye position and an eye movement of the occupant 2.

Furthermore, recorded image data of the occupant 2 and a corresponding evaluation can be used to determine information relating to a breathing frequency, to a pulse of the occupant 2, etc. As an alternative or in addition to recording vital parameters of the occupant 2, signals recorded by a so-called wearable, for example a smartwatch or a fitness tracker, can be used. For this purpose, the wearable is or can be wirelessly coupled to the control unit 4 of the device.

If, as shown in FIG. 1, the occupant 2 starts the eye training by actuating an operator control element, in particular an infotainment system in the vehicle 1, the occupant 2 is acoustically and/or visually informed to sit comfortably and upright and to relax their shoulders, so as to calm their breathing. The body posture of the occupant 2 is displayed mirrored on the display unit 8 as feedback to the occupant 2. To this end, the occupant 2 is displayed as an avatar, for example, whereby a respective task is output visualized on the display unit 8, possibly with the aid of the avatar.

The respective eye training is then carried out, as described further above by way of example.

Breathing is typically temporarily paused when carrying out such tasks, with a falter in the breathing of the occupant 2 being detected at least using the image data recorded by the camera 6.

If it is detected that the breathing of the occupant 2 falters, a corresponding message not to forget to breathe is output visually by displaying text, acoustically by outputting a voice message, for example that the occupant 2 should allow their breath to flow, and/or haptically. By way of example, the haptic message is output by means of the massage unit 7 arranged in the backrest 3.1 of the vehicle seat 3. By way of example, the massage unit 7 vibrates in a specified vibration pattern. Alternatively, or additionally, a seat massage of the massage unit 7 can be activated, for example, which reminds the occupant 2 to breathe and guides them into a next breathing movement.

By means of a further vibration pattern, which can be carried out by means of the massage unit 7, the occupant 2 on the vehicle seat 3 is informed of their body posture, which is simultaneously shown mirrored on the display unit 8 as visual feedback, for example by means of the avatar.

According to the task set, the occupant 2 is visually, acoustically and/or haptically given feedback about how they performed the task.

By way of example, the massage unit 7 can vibrate to reinforce the fact that the occupant 2 has performed the task well.

The vibration unit can also vibrate differently if the occupant 2 is instructed to do something, for example not to move their head 2.3, etc.

In one embodiment, the occupant 2 is acoustically praised, for example when instructed to move their head so as to paint using the nose tip 2.6.1, for the fact that the occupant 2 has performed the task very well and that every vertebra, in particular cervical vertebra, has been moved.

In the case of another task, the occupant 2 can, for example, be praised for the fact that they have performed the task very well and have worked and relaxed the small neck muscles when performing the task. It is then recommended to the occupant 2 that they relax for another 5 minutes.

While relaxing on the vehicle seat 3 in the reclined position or the relaxed position, the occupant 2 is acoustically and/or visually instructed to let their breath flow.

The vehicle seat 3 has an upright position of the backrest 3.1 during the eye training and the reclined or relaxed position during the relaxation.

In the context of the eye training, micromobilization thus takes place via feedback corresponding to the image data recorded by the camera 6. Feedback is also given in relation to the body posture of the occupant 2 and the recorded vital data.

If the occupant 2 is in their relaxation phase at the end of the eye training, the occupant 2 can be offered a heated eye mask and/or a cozy blanket.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9 (canceled)

10. A method for training the eyes of an occupant in a vehicle, the method comprising:
recording a head position or an eye movement of the occupant;
displaying, on a display unit, lines or dots;
prompting the occupant to track a course of the displayed lines by head movement or by eye movement; and
outputting feedback on a respectively recorded head position or eye movement of the occupant.

11. The method of claim 10, wherein a recorded occupant movement is displayed mirrored on the display unit.

12. The method of claim 10, wherein a nose tip on a face of the occupant is displayed as one of the dots on the display unit.

13. The method of claim 12, wherein, by moving the occupant moving the occupant's head, a two-dimensional shape is drawn by the nose tip, wherein the two-dimensional shape is displayed on the display unit.

14. The method of claim 10, further comprising:
monitoring breathing of the occupant during the training.

15. The method of claim 14, wherein the occupant is visually, acoustically, or haptically reminded to breathe if breathing stops or falters as a result of the training being performed.

16. The method of claim 15, wherein the occupant is haptically reminded to breathe by activation of a seat massage and the occupant is guided into a next breathing movement.

17. The method of claim 15, wherein the occupant is reminded to breathe by a vibration pattern of an activated vibration function.

18. The method of claim 17, wherein the occupant is reminded of their correct posture by a further vibration pattern.
